(19) United States
(12) Patent Application Publication
(10) Pub. No.: US 2023/0362777 A1
(43) Pub. Date: Nov. 9, 2023

(54) LOCATION SERVICE CONTINUITY IN CASE OF MOBILITY PROCEDURES

(71) Applicant: Nokia Technologies Oy, Espoo (FI)

(72) Inventors: Sankaran BALASUBRAMANIAM, Bangalore (IN); Shubhranshu SINGH, Seeheim-Jugenheim (DE); Mikko SÄILY, Laukkoski (FI)

(21) Appl. No.: 18/312,671

(22) Filed: May 5, 2023

(30) Foreign Application Priority Data
May 5, 2022 (IN) 202211026199

(51) Int. Cl. H04W 36/32; H04W 36/00

(52) U.S. Cl. CPC H04W 36/322; H04W 36/0058

(57) ABSTRACT

There are provided measures for location service continuity in case of mobility procedures. Such measures, for example, comprise, at a first network entity handling connection and mobility management tasks in a mobile network, receiving a first message indicative of completion of a mobility procedure with respect to a terminal in said mobile network, determining whether there is an ongoing location service session for said terminal, and transmitting, if there is said ongoing location service session for said terminal, a second message indicative of completion of said mobility procedure with respect to said terminal towards a second network entity configured to expose a location service for said terminal.

### FIELD

Various example embodiments described herein generally relate to location service continuity in case of mobility procedures. More specifically, various example embodiments relate to measures (including methods, apparatuses and computer program products) for realizing location service continuity in case of mobility procedures.

### BACKGROUND

In the context of handling LoCation Services (LCS) sessions during mobility procedures, a situation may arise in which an LCS session experiences a potentially undetected interruption or a termination or an improper working of the LCS session after a mobility procedure.

Hence, there is a desire to provide for location service continuity in case of mobility procedures.

### SUMMARY

Various example embodiments aim at addressing at least part of the issues, problems, and/or drawbacks described herein as well as those recognized by a person skilled in the art.

Various aspects of example embodiments are set out in the appended claims.

According to a first aspect, there is provided a method of a first network entity configured to handle connection and mobility management tasks in a mobile network, the method comprising receiving a first message indicative of completion of a mobility procedure with respect to a terminal in said mobile network, determining whether there is an ongoing location service session for said terminal, and transmitting, if there is said ongoing location service session for said terminal, a second message indicative of completion of said mobility procedure with respect to said terminal towards a second network entity configured to expose a location service for said terminal.

According to a second aspect, there is provided a method of a second network entity configured to expose a location service for a terminal in a mobile network, the method comprising receiving, from a first network entity configured to handle connection and mobility management tasks in said mobile network, a second message indicative of completion of a mobility procedure with respect to said terminal, and deciding, based on said completion of said mobility procedure with respect to said terminal, to continue a location service related procedure.

According to a third aspect, there is provided a method of a third network entity handling connection and mobility management tasks in a mobile network, the method comprising transmitting, towards a second network entity configured to expose a location service for a terminal, a request for a location report for said terminal, and storing a location service correlation identifier corresponding to a location service session initiated based on said request for said location report in combination with a before-mobility-procedure terminal identifier corresponding to said terminal.

According to a fourth aspect, there is provided an apparatus of a first network entity configured to handle connection and mobility management tasks in a mobile network, the apparatus comprising receiving circuitry configured to receive a first message indicative of completion of a mobility procedure with respect to a terminal in said mobile network, determining circuitry configured to determine whether there is an ongoing location service session for said terminal, and transmitting circuitry configured to transmit, if there is said ongoing location service session for said terminal, a second message indicative of completion of said mobility procedure with respect to said terminal towards a second network entity configured to expose a location service for said terminal.

According to a fifth aspect, there is provided an apparatus of a second network entity configured to expose a location service for a terminal in a mobile network, the apparatus comprising receiving circuitry configured to receive, from a first network entity configured to handle connection and mobility management tasks in said mobile network, a second message indicative of completion of a mobility procedure with respect to said terminal, and deciding circuitry configured to decide, based on said completion of said mobility procedure with respect to said terminal, to continue a location service related procedure.

According to a sixth aspect, there is provided an apparatus of a third network entity configured to handle connection and mobility management tasks in a mobile network, the apparatus comprising transmitting circuitry configured to transmit, towards a second network entity configured to expose a location service for a terminal, a request for a location report for said terminal, and storing circuitry configured to store a location service correlation identifier corresponding to a location service session initiated based on said request for said location report in combination with a before-mobility-procedure terminal identifier corresponding to said terminal.

According to a seventh aspect, there is provided an apparatus of a first network entity configured to handle connection and mobility management tasks in a mobile network, the apparatus comprising at least one processor, at least one memory including computer program code, and at least one interface configured for communication with at least another apparatus, the at least one processor, with the at least one memory and the computer program code, being configured to cause the apparatus to receive a first message indicative of completion of a mobility procedure with respect to a terminal in said mobile network, determine whether there is an ongoing location service session for said terminal, and transmit, if there is said ongoing location service session for said terminal, a second message indicative of completion of said mobility procedure with respect to said terminal towards a second network entity configured to expose a location service for said terminal.

According to an eighth aspect, there is provided an apparatus of a second network entity configured to expose a location service for a terminal in a mobile network, the apparatus comprising at least one processor, at least one memory including computer program code, and at least one interface configured for communication with at least another apparatus, the at least one processor, with the at least one memory and the computer program code, being configured to cause the apparatus to receive, from a first network entity configured to handle connection and mobility management tasks in said mobile network, a second message indicative of completion of a mobility procedure with respect to said terminal, and decide, based on said completion of said mobility procedure with respect to said terminal, to continue a location service related procedure.

According to a ninth aspect, there is provided an apparatus of a third network entity configured to handle connection and mobility management tasks in a mobile network, the apparatus comprising at least one processor, at least one memory including computer program code, and at least one interface configured for communication with at least another apparatus, the at least one processor, with the at least one memory and the computer program code, being configured to cause the apparatus to transmit, towards a second network entity configured to expose a location service for a terminal, a request for a location report for said terminal, and store a location service correlation identifier corresponding to a location service session initiated based on said request for said location report in combination with a before-mobility-procedure terminal identifier corresponding to said terminal.

According to a tenth aspect, there is provided a computer program product comprising computer-executable computer program code which, when the program is run on a computer (e.g. a computer of an apparatus according to any one of the aforementioned apparatus-related exemplary aspects of the present disclosure), is configured to cause the computer to carry out the method according to any one of the aforementioned method-related exemplary aspects of the present disclosure.

Such computer program product may comprise (or be embodied) a (tangible) computer-readable (storage) medium or the like on which the computer-executable computer program code is stored, and/or the program may be directly loadable into an internal memory of the computer or a processor thereof.

Any one of the above aspects enables an efficient handling of LCS sessions and potentially to avoidance or reduction of impacts of mobility procedures on LCS sessions to thereby solve at least part of the problems and drawbacks identified in relation to the prior art.

By way of example embodiments, there is provided location service continuity in case of mobility procedures. More specifically, by way of example embodiments, there are provided measures and mechanisms for realizing location service continuity in case of mobility procedures. In particular, by way of example embodiments, there are provided measures and mechanisms to handle LCS sessions during mobility procedures within 5G systems.

Thus, improvement is achieved by methods, apparatuses and computer program products enabling/realizing location service continuity in case of mobility procedures.

### BRIEF DESCRIPTION OF THE DRAWINGS

In the following, example embodiments will be described in greater detail by way of non-limiting examples with reference to the accompanying drawings, in which

FIG. 1 is a block diagram illustrating an apparatus according to at least one example embodiment,

FIG. 2 is a block diagram illustrating an apparatus according to at least one example embodiment,

FIG. 3 is a block diagram illustrating an apparatus according to at least one example embodiment,

FIG. 4 is a block diagram illustrating an apparatus according to at least one example embodiment,

FIG. 5 is a block diagram illustrating an apparatus according to at least one example embodiment,

FIG. 6 is a schematic diagram of a procedure according to at least one example embodiment,

FIG. 7 is a schematic diagram of a procedure according to at least one example embodiment,

FIG. 8 is a schematic diagram of a procedure according to at least one example embodiment,

FIG. 9 shows a schematic diagram of signaling sequences according to at least one example embodiment,

FIG. 10 shows a schematic diagram of signaling sequences according to at least one example embodiment,

FIG. 11 shows a schematic diagram of signaling sequences according to at least one example embodiment, and

FIG. 12 is a block diagram alternatively illustrating apparatuses according to at least one example embodiment.

### DETAILED DESCRIPTION

In the following, description will be made with respect to example embodiments. A person skilled in the art will appreciate that the detailed description is by no means to be understood as limiting, and may be more broadly applied.

It is to be noted that the following description refers to specifications being used as non-limiting examples for certain network configurations and deployments. Namely, the following description to 3GPP specifications, being used as non-limiting examples for certain network configurations and deployments. As such, the description of example embodiments given herein specifically refers to terminology which is directly related thereto. Such terminology is only used in the context of the example embodiments, and is not intended to be limiting in any way. Rather, any other communication or communication related system deployment(s), etc. may also be utilized.

Various example embodiments and implementations described herein and aspects thereof are described using several variants and/or alternatives. It is generally noted that, according to certain needs and constraints, all of the described variants and/or alternatives may be provided alone or in any combination (also including combinations of individual features of the various variants and/or alternatives).

It is further noted that the terms “first”, “second”, “third”, etc. do not imply a sequence or otherwise indicate a temporal relationship (unless explicitly and clearly articulated in the specification). Instead, if not otherwise indicated, these terms are mainly used to differentiate between steps, entities, units, etc.

According to example embodiments, in general terms, there are provided measures and mechanisms for (enabling/realizing) location service continuity in case of mobility procedures.

LCS is the end-to-end service through a 3^{rd} Generation Partnership Project (3GPP) 5^{th} Generation (5G) network that supports finding the location of a given user equipment (UE). It may span across multiple network functions in the 5G Core (5GC), e.g. location management function (LMF), access and mobility function (AMF), gateway mobile location centre (GMLC), the next generation radio access network (5G radio access network, NG-RAN), and the UE itself.

3GPP defines different types of mobility procedures for various scenarios. Mobility procedures may include handover, redirection, radio access network based notification area (RNA) update, etc. Variants of the procedures may be intra-gNB, inter-gNB, inter-AMF, 5GS<>EPS (evolved packet system), etc.

Handling of an LCS session during mobility procedures is not explicitly specified so far.

In particular, there is no approach on whether an ongoing LCS session shall be terminated or continued after the mobility procedure, and if continued, how the LCS continuity shall work.

Without such specified proceeding, for example, LCS sessions may be terminated upon a mobility procedure with the LCS Client having to re-initiate the session after the mobility procedure.

As another option, the LMF may not be aware of the mobility at all, leading to inaccurate positioning estimates.

As another option, since there are no clear specifications in relation to how to handle an LCS session during mobility procedures, inter-vendor tests might fail. As an example, an AMF from vendor-1 may think LCS continuity should work, whereas an LMF from vendor-2 may not support LCS continuity.

As another option, when LCS sessions are enabled as part of other critical services (like emergency calls), those other critical services could be impacted due to the missing clear specifications in relation to how to handle an LCS session during mobility procedures. This might lead to regulatory issues.

An analysis of different mobility procedures and positioning methods in different scenarios revealed that a serving AMF is reliably and simultaneously aware of an LCS session status of a given UE and of a completion of a mobility procedure for the given UE.

Heretofore, in particular, the following mobility procedures/positioning methods and scenarios are considered:
NG based or Xn based handover (HO) within 5GS,
RNA update in RRC-INACTIVE state,
change of gNB and/or change of serving AMF,
uplink (UL) or downlink (DL) or UL+DL positioning methods, and
mobile terminated location request (MTLR)/mobile originated location request (MOLR)/network initiated location request (NILR) LCS sessions.

In view of these findings, in brief, according to example embodiments, at the completion of the mobility procedure for a given UE, the serving AMF indicates the same to the LMF, if the UE has an ongoing LCS session.

According to further example embodiments, the LMF then continues the same LCS session, but may request new assistance information and/or new measurements.

According to still further example embodiments, the AMF route such requests (for new assistance information and/or new measurements) from the LMF to the new NG-RAN node.

In case of UL positioning methods and DL positioning methods with NG based HO, according to still further example embodiments, the serving gNB (for Xn based HO) or the serving AMF (for NG based HO) indicates the start of the mobility procedure to the LMF. This may help the LMF to pause the positioning estimation waiting for the mobility completion indication In Xn based HO, the RAN shall indicate to the LMF about the start of the HO. In NG based HO, the AMF shall indicate to the LMF about the start of the HO

Example embodiments are specified below in more detail.

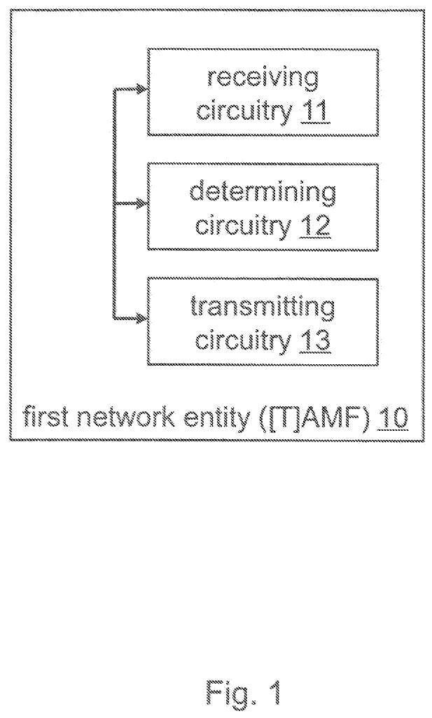

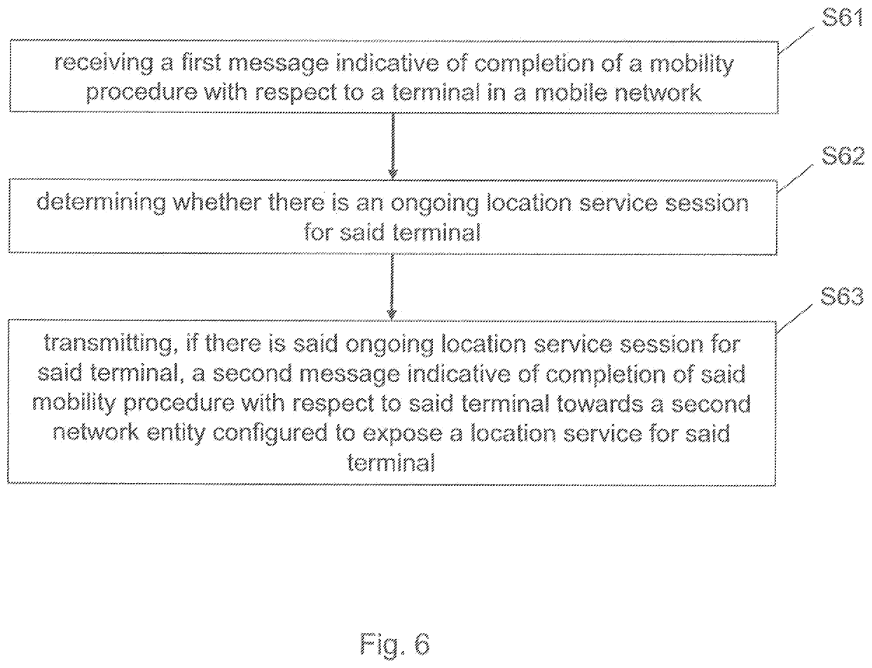

FIG. 1 is a block diagram illustrating an apparatus according to at least one example embodiment. The apparatus may be a first network entity 10 such as a (target) access and mobility function (entity) (handling connection and mobility management tasks in a mobile network) comprising receiving circuitry 11, determining circuitry 12, and transmitting circuitry 13. The receiving circuitry 11 receives a first message indicative of completion of a mobility procedure with respect to a terminal in said mobile network. The determining circuitry 12 determines whether there is an ongoing location service session for said terminal. The transmitting circuitry 13 transmits, if there is said ongoing location service session for said terminal, a second message indicative of completion of said mobility procedure with respect to said terminal towards a second network entity exposing a location service for said terminal. The second network entity may be an LMF. FIG. 6 is a schematic diagram of a procedure according to at least one example embodiment. The apparatus according to FIG. 1 may perform the method of FIG. 6 but is not limited to this method. The method of FIG. 6 may be performed by the apparatus of FIG. 1 but is not limited to being performed by this apparatus.

As shown in FIG. 6, a procedure according to example embodiments comprises an operation of receiving (S61) a first message indicative of completion of a mobility procedure with respect to a terminal in said mobile network, an operation of determining (S62) whether there is an ongoing location service session for said terminal, and an operation of transmitting (S63), if there is said ongoing location service session for said terminal, a second message indicative of completion of said mobility procedure with respect to said terminal towards a second network entity exposing a location service for said terminal.

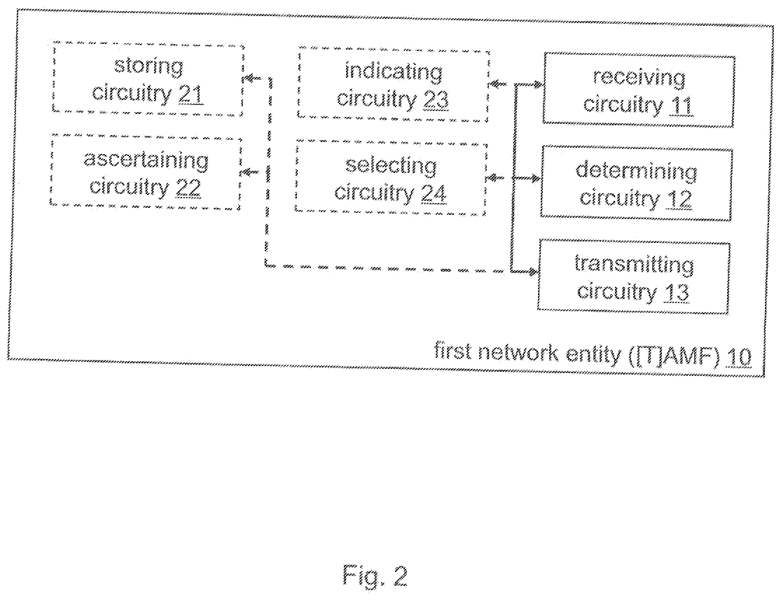

FIG. 2 is a block diagram illustrating an apparatus according to at least one example embodiment. In particular, FIG. 2 illustrates a variation of the apparatus shown in FIG. 1. The apparatus according to FIG. 2 may thus further comprise storing circuitry 21, ascertaining circuitry 22, indicating circuitry 23, and/or selecting circuitry 24.

In an embodiment at least some of the functionalities of the apparatus shown in FIG. 1 (or 2) may be shared between two physically separate devices forming one operational entity. Therefore, the apparatus may be seen to depict the operational entity comprising one or more physically separate devices for executing at least some of the described processes.

According to a variation of the procedure shown in FIG. 6, exemplary additional operations are given, which are inherently independent from each other as such. According to such variation, an exemplary method according to example embodiments may comprise an operation of transmitting, towards said second network entity, a request for a location report for said terminal, and an operation of storing a location service correlation identifier corresponding to a location service session initiated based on said request for said location report in combination with a before-mobility-procedure terminal identifier corresponding to said terminal.

According to a variation of the procedure shown in FIG. 6, exemplary details of the determining operation (S62) are given, which are inherently independent from each other as such. According to such variation, said first message is indicative of said before-mobility-procedure terminal identifier corresponding to said terminal. Further, such exemplary determining operation (S62) according to example embodiments may comprise an operation of ascertaining whether said location service correlation identifier is stored in combination with said before-mobility-procedure terminal identifier, and an operation of indicating, that there is said ongoing location service session for said terminal, if said location service correlation identifier is stored in combination with said before-mobility-procedure terminal identifier.

According to a variation of the procedure shown in FIG. 6, exemplary additional operations are given, which are inherently independent from each other as such. According to such variation, an exemplary method according to example embodiments may comprise an operation of receiving, from a third network entity handling connection and mobility management tasks in said mobile network, a third message indicative of said mobility procedure ongoing with respect to a terminal, wherein the third message being indicative of a location service correlation identifier corresponding to a location service session initiated for said terminal and of a before-mobility-procedure terminal identifier corresponding to said terminal, an operation of selecting (e.g., assigning) an after-mobility-procedure terminal identifier corresponding to said terminal, and an operation of storing said location service correlation identifier in combination with said after-mobility-procedure terminal identifier corresponding to said terminal. Said third network entity may be a source AMF.

According to a variation of the procedure shown in FIG. 6, exemplary additional operations are given, which are inherently independent from each other as such. According to such variation, an exemplary method according to example embodiments may comprise an operation of transmitting, towards a fourth network entity providing access to said mobile network, a fourth message indicative of said after-mobility-procedure terminal identifier. Said fourth network entity may be a target gNB.

According to a variation of the procedure shown in FIG. 6, exemplary details of the determining operation (S62) are given, which are inherently independent from each other as such. According to such variation, said first message is indicative of said after-mobility-procedure terminal identifier corresponding to said terminal. Further, such exemplary determining operation (S62) according to example embodiments may comprise an operation of ascertaining whether said location service correlation identifier is stored in combination with said after-mobility-procedure terminal identifier, and an operation of indicating, that there is said ongoing location service session for said terminal, if said location service correlation identifier is stored in combination with said after-mobility-procedure terminal identifier.

According to a variation of the procedure shown in FIG. 6, exemplary additional operations are given, which are inherently independent from each other as such. According to such variation, an exemplary method according to example embodiments may comprise an operation of transmitting, in response to receipt of said third message, a fifth message towards said second network entity, the fifth message being indicative of a start of said mobility procedure with respect to said terminal.

According to further example embodiments, said mobility procedure with respect to said terminal is any one of a handover procedure, a redirection procedure, or a radio access network based notification area update procedure.

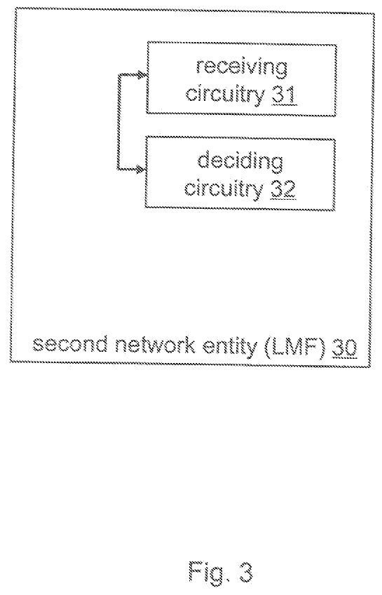

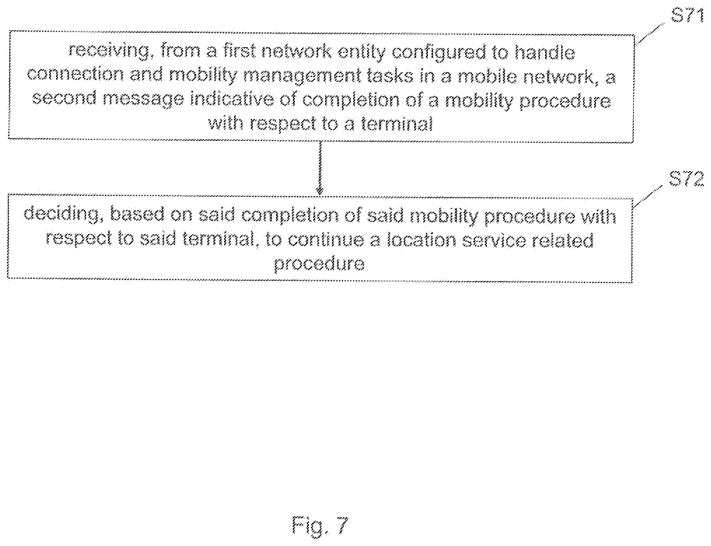

FIG. 3 is a block diagram illustrating an apparatus according to at least one example embodiment. The apparatus may be a second network entity 30 such as a location management function (entity) (exposing a location service for a terminal in a mobile network) comprising a receiving circuitry 31 and a deciding circuitry 32. The receiving circuitry 31 receives, from a first network entity handling connection and mobility management tasks in said mobile network, a second message indicative of completion of a mobility procedure with respect to said terminal. The deciding circuitry 32 decides, based on said completion of a mobility procedure with respect to said terminal, to continue a location service related procedure. The first network entity may be a (target) AMF. FIG. 7 is a schematic diagram of a procedure according to at least one example embodiment. The apparatus according to FIG. 3 may perform the method of FIG. 7 but is not limited to this method. The method of FIG. 7 may be performed by the apparatus of FIG. 3 but is not limited to being performed by this apparatus.

As shown in FIG. 7, a procedure according to at least one example embodiment comprises an operation of receiving (S71), from a first network entity handling connection and mobility management tasks in said mobile network, a second message indicative of completion of a mobility procedure with respect to said terminal, an operation of deciding (S72), based on said completion of a mobility procedure with respect to said terminal, to continue a location service related procedure.

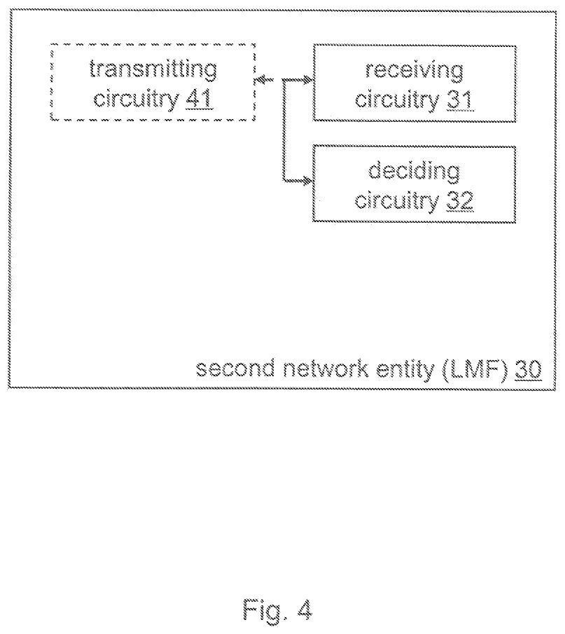

FIG. 4 is a block diagram illustrating an apparatus according to at least one example embodiment. In particular, FIG. 4 illustrates a variation of the apparatus shown in FIG. 3. The apparatus according to FIG. 4 may thus further comprise transmitting circuitry 41.

In at least one example embodiment, at least some of the functionalities of the apparatus shown in FIG. 3 (or 4) may be shared between two physically separate devices forming one operational entity. Therefore, the apparatus may be seen to depict the operational entity comprising one or more physically separate devices for executing at least some of the described processes.

According to a variation of the procedure shown in FIG. 7, exemplary details of the requesting operation (S73) are given, which are inherently independent from each other as such. Such exemplary requesting operation (S73) according to example embodiments may comprise an operation of transmitting a first request message requesting transmission point information from a fourth network entity providing access to said mobile network, an operation of transmitting a second request message requesting location service assistance data from said fourth network entity, and/or an operation of transmitting a third request message requesting location service measurements. Said fourth network entity may be a target gNB.

According to a variation of the procedure shown in FIG. 7, exemplary additional operations are given, which are inherently independent from each other as such. According to such variation, an exemplary method according to example embodiments may comprise an operation of receiving, from said first network entity, a request for a location report for said terminal.

According to a variation of the procedure shown in FIG. 7, exemplary additional operations are given, which are inherently independent from each other as such. According to such variation, an exemplary method according to example embodiments may comprise an operation of receiving a fifth message from a fifth network entity providing access to said mobile network, the fifth message being indicative of a start of said mobility procedure with respect to said terminal. Said fifth network entity may be a source gNB.

According to a variation of the procedure shown in FIG. 7, exemplary additional operations are given, which are inherently independent from each other as such. According to such variation, an exemplary method according to example embodiments may comprise an operation of receiving, from a third network entity handling connection and mobility management tasks in said mobile network, a request for a location report for said terminal. Said third network entity may be a source AMF.

According to a variation of the procedure shown in FIG. 7, exemplary additional operations are given, which are inherently independent from each other as such. According to such variation, an exemplary method according to example embodiments may comprise an operation of receiving a fifth message from said first network entity, the fifth message being indicative of a start of said mobility procedure with respect to said terminal.

According to further example embodiments, said mobility procedure with respect to said terminal is any one of a handover procedure, a redirection procedure, or a radio access network based notification area update procedure.

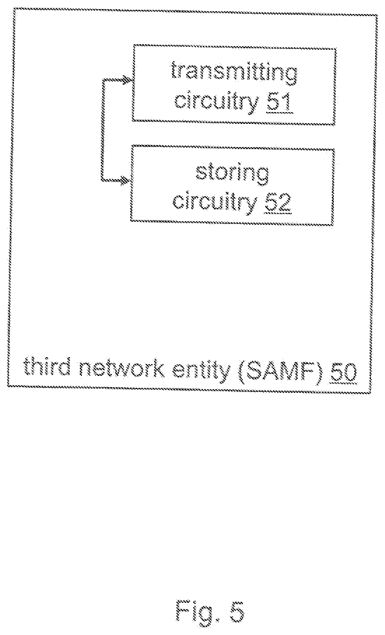

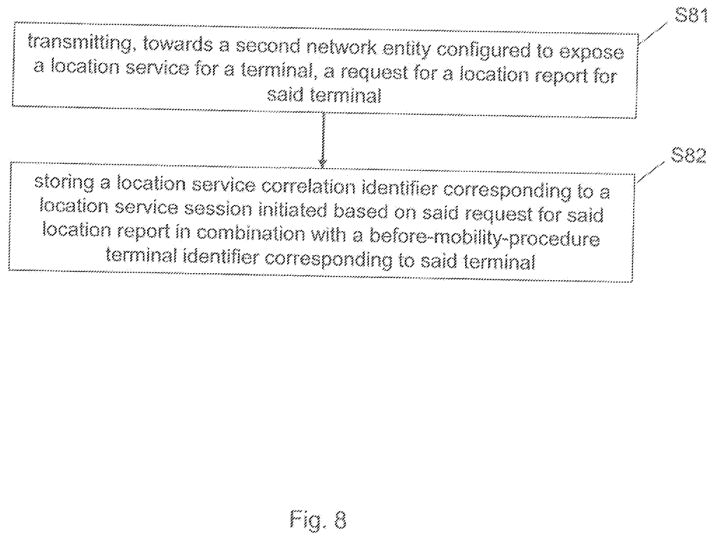

FIG. 5 is a block diagram illustrating an apparatus according to at least one example embodiment. The apparatus may be a third network entity 50 such as a source access and mobility function (entity) (handling connection and mobility management tasks in a mobile network) comprising transmitting circuitry 51 and a storing circuitry 52. The transmitting circuitry 51 transmits, towards a second network entity exposing a location service for a terminal, a request for a location report for said terminal. The storing circuitry 52 stores a location service correlation identifier corresponding to a location service session initiated based on said request for said location report in combination with a before-mobility-procedure terminal identifier corresponding to said terminal. The second network entity may be an LMF. FIG. 8 is a schematic diagram of a procedure according to at least one example embodiment. The apparatus according to FIG. 5 may perform the method of FIG. 8 but is not limited to this method. The method of FIG. 8 may be performed by the apparatus of FIG. 5 but is not limited to being performed by this apparatus.

As shown in FIG. 8, a procedure according to at least one example embodiment comprises an operation of transmitting (S81), towards a second network entity exposing a location service for a terminal, a request for a location report for said terminal, and an operation of storing (S82) a location service correlation identifier corresponding to a location service session initiated based on said request for said location report in combination with a before-mobility-procedure terminal identifier corresponding to said terminal.

In an embodiment at least some of the functionalities of the apparatus shown in FIG. 5 may be shared between two physically separate devices forming one operational entity. Therefore, the apparatus may be seen to depict the operational entity comprising one or more physically separate devices for executing at least some of the described processes.

According to a variation of the procedure shown in FIG. 8, exemplary additional operations are given, which are inherently independent from each other as such. According to such variation, an exemplary method according to example embodiments may comprise an operation of transmitting, towards a first network entity handling connection and mobility management tasks in said mobile network, a third message indicative of a mobility procedure ongoing with respect to said terminal, wherein the third message being indicative of said location service correlation identifier and of said before-mobility-procedure terminal identifier corresponding to said terminal. Said first network entity may be a (target) AMF.

According to further example embodiments, said mobility procedure with respect to said terminal is any one of a handover procedure, a redirection procedure, or a radio access network based notification area update procedure.

Example embodiments outlined and specified above are explained below in more specific terms.

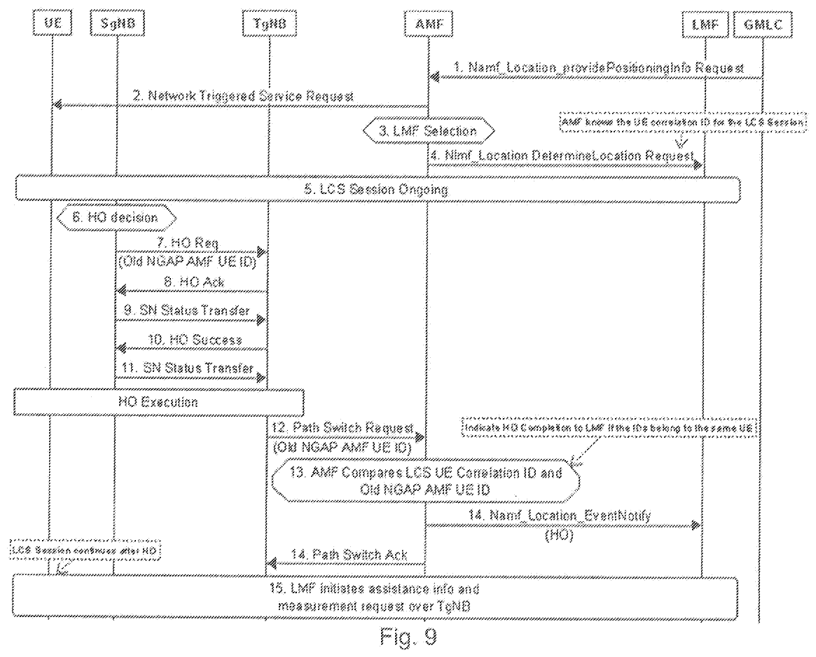

FIG. 9 shows a schematic diagram of signaling sequences according to at least one example embodiment, and in particular illustrates LCS continuity for Xn based HO (success).

In steps 1 to 3 of FIG. 9, a processing for e.g. network triggered LCS is performed.

In a step 4 of FIG. 9, according to example embodiments, the AMF transmits e.g. Nlmf_Location DetermineLocation Request, and thus, knows the LCS correlation ID of the UE for which the LCS session is being initiated. According to example embodiments, the AMF stores the same.

In steps 5 to 11 of FIG. 9, a mobility processing (e.g. handover processing) is performed.

In a step 12 of FIG. 9, according to example embodiments, the AMF receives e.g. a Path Switch Request, and thus, comes to know of completion of the Xn based HO. According to example embodiments, the target gNB also sends the old NG application protocol (NGAP) AMF UE ID assigned by the AMF e.g. in a message. The target gNB got this NGAP AMF UE ID from the source gNB in Step 7 of FIG. 9.

In a step 13 of FIG. 9, according to example embodiments, the AMF checks if this UE ID (NGAP AMF UE ID) has an associated LCS session that is active (by checking for the corresponding LCS correlation ID).

In a step 14 of FIG. 9, if such an LCS session exists, then, according to example embodiments, the AMF invokes e.g. the service based interface (SBI) application programming interface (API) Namf_Location_EventNotify or Namf_EventExposure or information transmission according to any other API towards the LMF. This API is enhanced to also indicate handover completion. In other words, according to example embodiments, the Namf_Location_EventNotify or Namf_EventExposure or information transmission according to any other API towards the LMF is indicative of the HO in this case.

Consequently, according to example embodiments, the LMF would then know that the UE has moved after the previous LCS session was started. This could mean the following:
the list of transmission points (TRP) that are measuring (for UL methods) may should be updated,
the sounding reference signal (SRS) information (for UL methods) may have to be updated since the UE would have a new SRS scheduling allocated in the target gNB, and
for DL methods, the positioning reference signal (PRS) information may have to be got for the TRPs corresponding to the target gNB.

In the step 14 of FIG. 9, when the LMF receives the notification for mobility completion, according to example embodiments, it will keep the LCS session on, but may require updated information to make the measurements accurate.

Thus, in a step 15 of FIG. 9, according to example embodiments, the LMF may choose to request for TRP information from the target gNB (NR PCI, NR CGI, NR ARFCN, PRS configuration, SSB information, SFN initialization time, spatial direction information, geographical coordinates), and request the same. Further, according to example embodiments, the LMF may choose to get new assistance data from the target gNB (the routing to the new gNB shall be taken care of by the AMF; the LMF just can resend the “NRPPa: Positioning Information Request” message), and request the same. Further, according to example embodiments, the LMF may then request for a new set of measurements from the NG-RAN (for UL methods) or the UE (for DL methods).

As can be observed, the entire procedure is done in a way where GMLC and/or LCS client is not aware of the mobility handling, and the LCS session continuity is ensured.

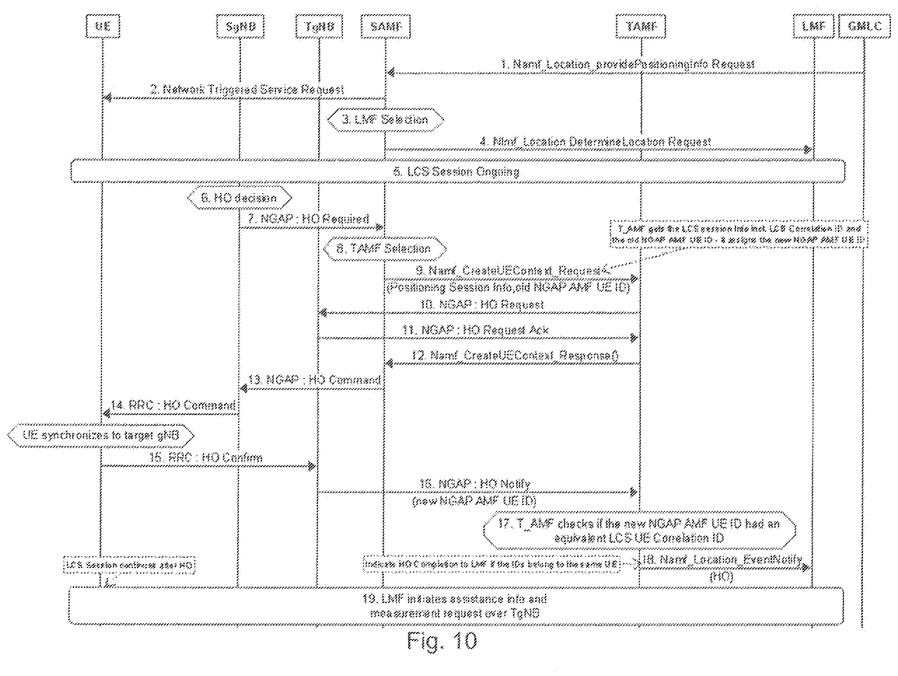

FIG. 10 shows a schematic diagram of signaling sequences according to at least one example embodiment, and in particular illustrates LCS continuity for NG based HO (success).

In steps 1 to 3 of FIG. 10, a processing for e.g. network triggered LCS is performed.

In a step 4 of FIG. 10, according to example embodiments, the source AMF (SAMF) transmits e.g. Nlmf_Location DetermineLocation Request, and thus, knows the LCS correlation ID of the UE for which the LCS session is being initiated. According to example embodiments, the source AMF stores the same.

In steps 5 to 8 of FIG. 10, (part of) a mobility processing (e.g. handover processing) is performed.

In a step 9 of FIG. 10, according to example embodiments, the source AMF sends LCS session information to the target AMF along with the assigned old NGAP AMF UE ID.

In a step 10 of FIG. 10, according to example embodiments, the target AMF assigns a new NGAP AMF UE ID for the UE as per HO signaling.

In steps 11 to 15 of FIG. 10, (part of) the mobility processing (e.g. handover processing) is performed.

In a step 16 of FIG. 10, according to example embodiments, the HO completes, and the target AMF (TAMF) gets the notification with the new NGAP AMF UE ID.

In a step 17 of FIG. 10, according to example embodiments, the TAMF then checks if that UE had an existing LCS session on the source AMF (using the data it got in step 9 of FIG. 10).

In a step 18 of FIG. 10, according to example embodiments, if such an LCS session exists, then the AMF invokes e.g. the SBI API Namf_Location_EventNotify or Namf_EventExposure or information transmission according to any other API towards the LMF. This API is enhanced to also indicate handover completion. In other words, according to example embodiments, the Namf_Location_EventNotify or Namf_EventExposure or information transmission according to any other API towards the LMF is indicative of the HO in this case.

The LMF may then choose to do the same actions as described with reference to FIG. 9 (in particular steps 14 and 15 of FIG. 9) for the Xn based HO to keep the LCS session active, but with updated, more accurate parameters and measurements.

In other words, in a step 19 of FIG. 10, according to example embodiments, the LMF may choose to request for TRP information from the target gNB (NR PCI, NR CGI, NR ARFCN, PRS configuration, SSB information, SFN initialization time, spatial direction information, geographical coordinates), and request the same. Further, according to example embodiments, the LMF may choose to get new assistance data from the target gNB (the routing to the new gNB shall be taken care of by the AMF; the LMF can resend the “NRPPa: Positioning Information Request” message), and request the same. Further, according to example embodiments, the LMF may then request for a new set of measurements from the NG-RAN (for UL methods) or the UE (for DL methods).

This completes the LCS session continuity for NG based HO.

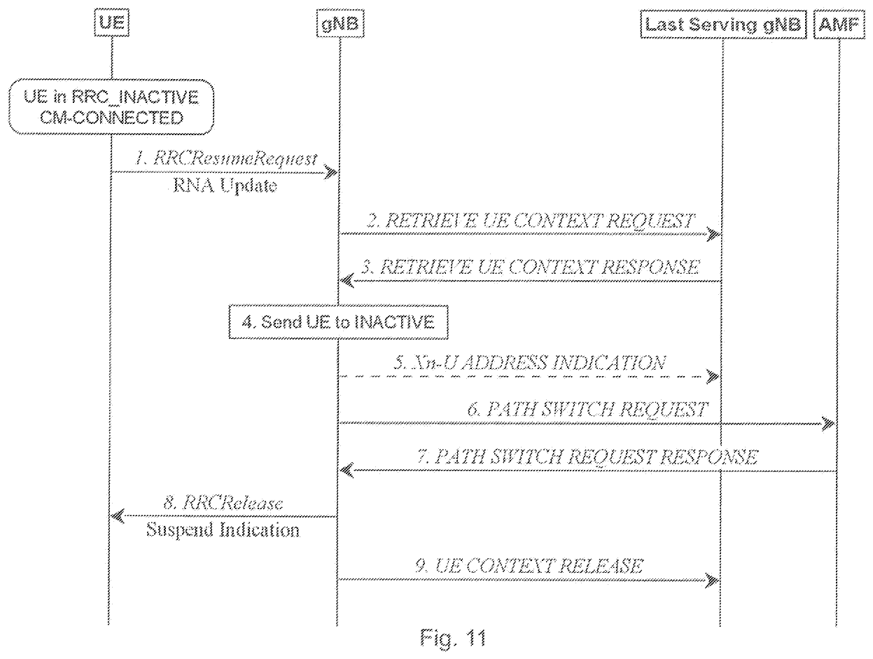

FIG. 11 shows a schematic diagram of signaling sequences according to at least one example embodiment, and in particular illustrates a call flow during an RNA update as according to e.g. the RNA update call from TS 38.300 related to 3GPP Rel-17, defining positioning services during RRC-INACTIVE state.

In such RNA update call flow of FIG. 11, in a step 6 of FIG. 11, similar to the Xn based HO handling discussion with reference to FIG. 9, the AMF receives (e.g.) a Path Switch Request (similar to step 12 of FIG. 9).

According to example embodiments, in this scenario, the AMF checks whether an LCS session was active for that UE and if so, invokes e.g. the SBI API Namf_Location_EventNotify or Namf_EventExposure or information transmission according to any other API towards the LMF, as discussed with reference to steps 13 and 14 of FIG. 9. In other words, according to example embodiments, the receipt of the Path Switch Request in step 6 of FIG. 11 (e.g., in the RNA update context illustrated in FIG. 11) triggers the operations discussed with reference to steps 13 to 15 of FIG. 9 (like the receipt of the Path Switch Request in step 12 of FIG. 9 triggers the operations discussed with reference to steps 13 to 15 of FIG. 9).

This API is enhanced to also indicate handover completion. In other words, according to example embodiments, the Namf_Location_EventNotify or Namf_EventExposure or information transmission according to any other API towards the LMF is indicative of the HO in this case.

According to example embodiments, the LMF behavior is as described with reference to FIGS. 9 and 10.

In particular, the LMF may then choose to do the same actions as described with reference to FIG. 9 (in particular steps 14 and 15 of FIG. 9) for the Xn based HO to keep the LCS session active, but with updated, more accurate parameters and measurements.

In other words, according to example embodiments, upon receipt of the Namf_Location_EventNotify or Namf_EventExposure or information transmission according to any other API, the LMF may choose to request for TRP information from the target gNB (NR PCI, NR CGI, NR ARFCN, PRS configuration, SSB information, SFN initialization time, spatial direction information, geographical coordinates), and request the same. Further, according to example embodiments, the LMF may choose to get new assistance data from the target gNB (the routing to the new gNB shall be taken care of by the AMF; the LMF can resend the “NRPPa : Positioning Information Request” message), and request the same. Further, according to example embodiments, the LMF may then request for a new set of measurements from the NG-RAN (for UL methods) or the UE (for DL methods).

According to example embodiments, the above approaches are particularly applicable to:
UL or DL or UL+DL positioning methods, and
MTLR/MOLR/NILR LCS sessions.
NG/Xn based mobility procedures

According to example embodiments, a notification for HO start towards the LMF is provided.

In particular, according to these example embodiments, the HO start indication can be sent in the following scenarios:

If the used positioning method is an UL method, and the HO type is Xn based, then, according to example embodiments, when the HO decision is made in step 6 of FIG. 9, the RAN indicates the HO start to the LMF.

On the other hand, if the used positioning method is an UL method, and the HO type is NG based, then, according to example embodiments, when the TAMF receives, in step 9 of FIG. 10, the request to transfer UE context, the TAMF indicates the HO start to the LMF.

Furthermore, if the used positioning method is a DL method, and the HO type is NG based, then, according to example embodiments, when the TAMF receives, in step 9 of FIG. 10, the request to transfer UE context, the TAMF indicates the HO start to the LMF.

The above-described procedures and functions may be implemented by respective functional elements, processors, or the like, as described below.

In the foregoing description of the network entity, units that are relevant for understanding the principles described herein have been denoted using functional blocks. The network entity may comprise further units that are utilized for its respective operation. However, a description of these units is omitted in this specification. The arrangement of the functional blocks of the devices is not construed to limit the disclosure, and the functions may be performed by one block or further split into sub-blocks.

When in the foregoing description it is stated that the apparatus, e.g. network entity (or some other means) is configured to perform some function, this is to be construed to be a description stating that a (e.g., at least one) processor or corresponding circuitry, potentially in cooperation with computer program code stored in the memory of the respective apparatus, is configured to cause the apparatus to perform at least the thus mentioned function.

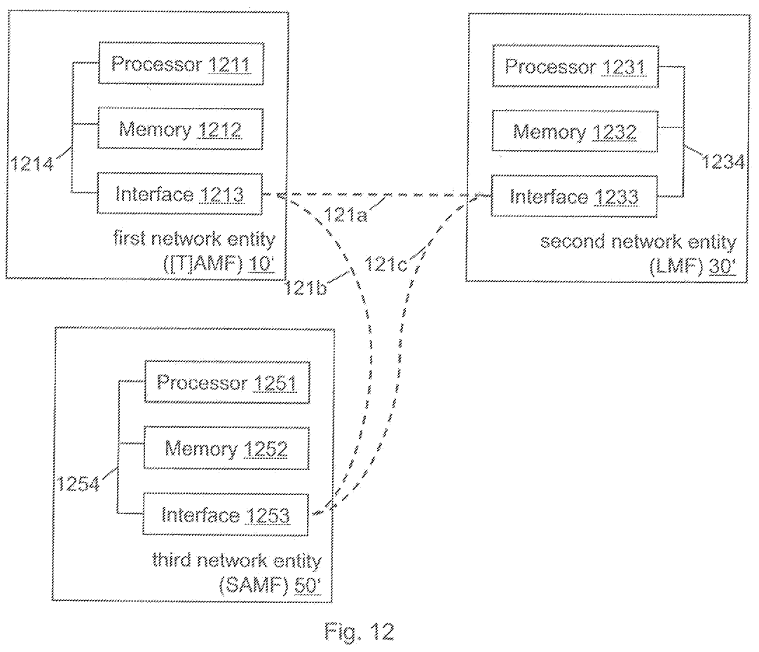

In FIG. 12, an alternative illustration of apparatuses according to at least one example embodiment is depicted. As indicated in FIG. 12, according to example embodiments, the apparatus (first network entity) 10′ (corresponding to the first network entity 10) comprises a processor 1211, a memory 1212 and an interface 1213, which are connected by a bus 1214 or the like. Further, according to example embodiments, the apparatus (second network entity) 30′ (corresponding to the second network entity 30) comprises a processor 1231, a memory 1232 and an interface 1233, which are connected by a bus 1234 or the like. Further, according to example embodiments, the apparatus (third network entity) 50′ (corresponding to the third network entity 50) comprises a processor 1251, a memory 1252 and an interface 1253, which are connected by a bus 1254 or the like. The apparatuses may be connected via links 121a, 121b, 121c, respectively.

The processor 1211/1231/1251 and/or the interface 1213/1233/1253 may also include a modem or the like to facilitate communication over a (hardwire or wireless) link, respectively. The interface 1213/1233/1253 may include a suitable transceiver coupled to one or more antennas or communication means for (hardwire or wireless) communications with the linked or connected device(s), respectively. The interface 1213/1233/1253 is generally configured to communicate with at least one other apparatus, e.g. the interface thereof.

The memory 1212/1232/1252 may store respective programs assumed to include program instructions or computer program code that, when executed by the respective processor, enables the respective electronic device or apparatus to operate in accordance with the example embodiments.

In general terms, the respective devices/apparatuses (and/or parts thereof) may represent means for performing respective operations and/or exhibiting respective functionalities, and/or the respective devices (and/or parts thereof) may have functions for performing respective operations and/or exhibiting respective functionalities.

When in the subsequent description it is stated that the processor (or some other means) is configured to perform some function, this is to be construed to be a description stating that at least one processor, potentially in cooperation with computer program code stored in the memory of the respective apparatus, is configured to cause the apparatus to perform at least the thus mentioned function.

According to example embodiments, an apparatus representing the first network entity 10 (handling connection and mobility management tasks in a mobile network) comprises at least one processor 1211, at least one memory 1212 including computer program code, and at least one interface 1213 configured for communication with at least another apparatus. The processor (e.g. the at least one processor 1211, with the at least one memory 1212 and the computer program code) is configured to perform receiving a first message indicative of completion of a mobility procedure with respect to a terminal in said mobile network (thus the apparatus comprising corresponding means for receiving), to perform determining whether there is an ongoing location service session for said terminal (thus the apparatus comprising corresponding means for determining), and to perform transmitting, if there is said ongoing location service session for said terminal, a second message indicative of completion of said mobility procedure with respect to said terminal towards a second network entity exposing a location service for said terminal (thus the apparatus comprising corresponding means for transmitting).

According to example embodiments, an apparatus representing the second network entity 30 (exposing a location service for a terminal in a mobile network) comprises at least one processor 1231, at least one memory 1232 including computer program code, and at least one interface 1233 configured for communication with at least another apparatus. The processor (e.g. the at least one processor 1231, with the at least one memory 1232 and the computer program code) is configured to perform receiving, from a first network entity handling connection and mobility management tasks in said mobile network, a second message indicative of completion of a mobility procedure with respect to said terminal (thus the apparatus comprising corresponding means for receiving), to perform deciding, based on said completion of a mobility procedure with respect to said terminal, to continue a location service related procedure (thus the apparatus comprising corresponding means for deciding).

According to example embodiments, an apparatus representing the third network entity 50 (handling connection and mobility management tasks in a mobile network) comprises at least one processor 1251, at least one memory 1252 including computer program code, and at least one interface 1253 configured for communication with at least another apparatus. The processor (e.g. the at least one processor 1251, with the at least one memory 1252 and the computer program code) is configured to perform transmitting, towards a second network entity exposing a location service for a terminal, a request for a location report for said terminal (thus the apparatus comprising corresponding means for transmitting), and to perform storing a location service correlation identifier corresponding to a location service session initiated based on said request for said location report in combination with a before-mobility-procedure terminal identifier corresponding to said terminal (thus the apparatus comprising corresponding means for storing).

For further details regarding the operability/functionality of the individual apparatuses, reference is made to the above description in connection with any one of FIGS. 1 to 11, respectively.

As described herein, it should be noted that
method steps likely to be implemented as software code portions and being run using a processor at a network server or network entity (as examples of devices, apparatuses and/or modules thereof, or as examples of entities including apparatuses and/or modules therefore), are software code independent and can be specified using any known or future developed programming language as long as the functionality defined by the method steps is preserved;
generally, any method step is suitable to be implemented as software or by hardware without changing the idea of the embodiments and its modification in terms of the functionality implemented;
method steps and/or devices, units or means likely to be implemented as hardware components at the above-defined apparatuses, or any module(s) thereof, (e.g., devices carrying out the functions of the apparatuses according to the embodiments as described above) are hardware independent and can be implemented using any known or future developed hardware technology or any hybrids of these, such as MOS (Metal Oxide Semiconductor), CMOS (Complementary MOS), BiMOS (Bipolar MOS), BiCMOS (Bipolar CMOS), ECL (Emitter Coupled Logic), TTL (Transistor-Transistor Logic), etc., using for example ASIC (Application Specific IC (Integrated Circuit)) components, FPGA (Field-programmable Gate Arrays) components, CPLD (Complex Programmable Logic Device) components or DSP (Digital Signal Processor) components;
devices, units or means (e.g. the above-defined network entity or network register, or any one of their respective units/means) can be implemented as individual devices, units or means, but this does not exclude that they are implemented in a distributed fashion throughout the system, as long as the functionality of the device, unit or means is preserved;
an apparatus like the user equipment and the network entity/network register may be represented by a semiconductor chip, a chipset, or a (hardware) module comprising such chip or chipset; this, however, does not exclude the possibility that a functionality of an apparatus or module, instead of being hardware implemented, be implemented as software in a (software) module such as a computer program or a computer program product comprising executable software code portions for execution/being run on a processor;
a device may be regarded as an apparatus or as an assembly of more than one apparatus, whether functionally in cooperation with each other or functionally independently of each other but in a same device housing, for example.

In general, it is to be noted that respective functional blocks or elements as described herein can be implemented by any means, either in hardware and/or software, respectively, if it is only adapted to perform the described functions of the respective parts. The mentioned method steps can be realized in individual functional blocks or by individual devices, or one or more of the method steps can be realized in a single functional block or by a single device.

Generally, any method step is suitable to be implemented as software or by hardware without changing the idea of the present disclosure. Devices and means can be implemented as individual devices, but this does not exclude that they are implemented in a distributed fashion throughout the system, as long as the functionality of the device is preserved.

Software in the sense of the present description comprises software code as such comprising code means or portions or a computer program or a computer program product for performing the respective functions, as well as software (or a computer program or a computer program product) embodied on a tangible medium such as a computer-readable (storage) medium having stored thereon a respective data structure or code means/portions or embodied in a signal or in a chip, potentially during processing thereof.

Any combination of method steps and operations described herein, and any combination of nodes, apparatuses, modules or elements described herein, are applicable.

In view of the above, there are provided measures for location service continuity in case of mobility procedures. Such measures may, for example, comprise, at a first network entity handling connection and mobility management tasks in a mobile network, receiving a first message indicative of completion of a mobility procedure with respect to a terminal in said mobile network, determining whether there is an ongoing location service session for said terminal, and transmitting, if there is said ongoing location service session for said terminal, a second message indicative of completion of said mobility procedure with respect to said terminal towards a second network entity exposing a location service for said terminal.

Even though the example embodiments are described above with reference to the accompanying drawings, it is to be understood that the example embodiments are not restricted thereto. Rather, various modifications may be apparent to those skilled in the art without departing from the scope of the example embodiments.

### List of Acronyms and Abbreviations

3GPP 3rd Generation Partnership Project
5G 5th Generation
5GC 5G Core
5GS 5G System
AMF access and mobility function
API application programming interface
DL downlink
EPS evolved packet system
GMLC gateway mobile location centre
gNB 5G base station
HO handover
LCS LoCation Services
LMF location management function
MTLR mobile terminated location request
MOLR mobile originated location request
NG-RAN next generation (5G) radio access network
NGAP NG application protocol
NILR network initiated location request
PRS positioning reference signal
RNA radio access network based notification area
SAMF source AMF
SBI service based interface
SgNB source gNB
SRS sounding reference signal
TAMF target AMF
TgNB target gNB
TRP transmission point
UE user equipment
UL uplink

1. An apparatus of a first network entity configured to handle connection and mobility management tasks in a mobile network, the apparatus comprising
at least one processor,
at least one memory including computer program code, and
at least one interface configured for communication with at least another apparatus,
the at least one processor, with the at least one memory and the computer program code, being configured to cause the apparatus to:
receive a first message indicative of completion of a mobility procedure with respect to a terminal in said mobile network,
determine whether there is an ongoing location service session for said terminal, and
transmit, if there is said ongoing location service session for said terminal, a second message indicative of completion of said mobility procedure with respect to said terminal towards a second network entity configured to expose a location service for said terminal.

2. The apparatus according to claim 1, wherein
the at least one processor, with the at least one memory and the computer program code, being configured to cause the apparatus to:
transmit, towards said second network entity, a request for a location report for said terminal, and
store a location service correlation identifier corresponding to a location service session initiated based on said request for said location report in combination with a before-mobility-procedure terminal identifier corresponding to said terminal.

3. The apparatus according to claim 2, wherein
said first message is indicative of said before-mobility-procedure terminal identifier corresponding to said terminal, and
in relation to said determining, the at least one processor, with the at least one memory and the computer program code, being configured to cause the apparatus to:
ascertain whether said location service correlation identifier is stored in combination with said before-mobility-procedure terminal identifier, and
indicate, that there is said ongoing location service session for said terminal, if said location service correlation identifier is stored in combination with said before-mobility-procedure terminal identifier.

4. The apparatus according to claim 1, wherein
the at least one processor, with the at least one memory and the computer program code, being configured to cause the apparatus to:
receive, from a third network entity configured to handle connection and mobility management tasks in said mobile network, a third message indicative of said mobility procedure ongoing with respect to a terminal, the third message being indicative of a location service correlation identifier corresponding to a location service session initiated for said terminal and of a before-mobility-procedure terminal identifier corresponding to said terminal,
select an after-mobility-procedure terminal identifier corresponding to said terminal, and
store said location service correlation identifier in combination with said after-mobility-procedure terminal identifier corresponding to said terminal.

5. The apparatus according to claim 4, wherein
the at least one processor, with the at least one memory and the computer program code, being configured to cause the apparatus to:
transmit, towards a fourth network entity configured to provide access to said mobile network, a fourth message indicative of said after-mobility-procedure terminal identifier.

6. The apparatus according to claim 4, wherein
said first message is indicative of said after-mobility-procedure terminal identifier corresponding to said terminal, and
in relation to said determining, the at least one processor, with the at least one memory and the computer program code, being configured to cause the apparatus to:
ascertain whether said location service correlation identifier is stored in combination with said after-mobility-procedure terminal identifier, and
indicate, that there is said ongoing location service session for said terminal, if said location service correlation identifier is stored in combination with said after-mobility-procedure terminal identifier.

7. The apparatus according to any of claim 4, wherein
the at least one processor, with the at least one memory and the computer program code, being configured to cause the apparatus to:
transmit, in response to receipt of said third message, a fifth message towards said second network entity, the fifth message being indicative of a start of said mobility procedure with respect to said terminal.

8. The apparatus according to any of claim 1, wherein
said mobility procedure with respect to said terminal is any one of a handover procedure, a redirection procedure, or a radio access network based notification area update procedure.

9. An apparatus of a second network entity configured to expose a location service for a terminal in a mobile network, the apparatus comprising
at least one processor,
at least one memory including computer program code, and
at least one interface configured for communication with at least another apparatus,
the at least one processor, with the at least one memory and the computer program code, being configured to cause the apparatus to:
receive, from a first network entity configured to handle connection and mobility management tasks in said mobile network, a second message indicative of completion of a mobility procedure with respect to said terminal,
decide, based on said completion of said mobility procedure with respect to said terminal, to continue a location service related procedure.

10. The apparatus according to claim 9, wherein
in relation to said requesting, the at least one processor, with the at least one memory and the computer program code, being configured to cause the apparatus to transmit at least one of:
a first request message requesting transmission point information from a fourth network entity configured to provide access to said mobile network,
a second request message requesting location service assistance data from said fourth network entity, or
a third request message requesting location service measurements.

11. The apparatus according to claim 9, wherein
the at least one processor, with the at least one memory and the computer program code, being configured to cause the apparatus to:
receive, from said first network entity, a request for a location report for said terminal.

12. The apparatus according to claim 11, wherein
the at least one processor, with the at least one memory and the computer program code, being configured to cause the apparatus to:
receive a fifth message from a fifth network entity configured to provide access to said mobile network, the fifth message being indicative of a start of said mobility procedure with respect to said terminal.

13. The apparatus according to claim 9, wherein
the at least one processor, with the at least one memory and the computer program code, being configured to cause the apparatus to:
receive, from a third network entity configured to handle connection and mobility management tasks in said mobile network, a request for a location report for said terminal.

14. The apparatus according to claim 13, wherein
the at least one processor, with the at least one memory and the computer program code, being configured to cause the apparatus to:
receive a fifth message from said first network entity, the fifth message being indicative of a start of said mobility procedure with respect to said terminal.

15. The apparatus according to any of claim 9, wherein
said mobility procedure with respect to said terminal is any one of a handover procedure, a redirection procedure, or a radio access network based notification area update procedure.

16. An apparatus of a third network entity configured to handle connection and mobility management tasks in a mobile network, the apparatus comprising
at least one processor,
at least one memory including computer program code, and
at least one interface configured for communication with at least another apparatus,
the at least one processor, with the at least one memory and the computer program code, being configured to cause the apparatus to:
transmit, towards a second network entity configured to expose a location service for a terminal, a request for a location report for said terminal, and
store a location service correlation identifier corresponding to a location service session initiated based on said request for said location report in combination with a before-mobility-procedure terminal identifier corresponding to said terminal.

17. The apparatus according to claim 16, wherein
the at least one processor, with the at least one memory and the computer program code, being configured to cause the apparatus to:
transmit, towards a first network entity configured to handle connection and mobility management tasks in said mobile network, a third message indicative of a mobility procedure ongoing with respect to said terminal, the third message being indicative of said location service correlation identifier and of said before-mobility-procedure terminal identifier corresponding to said terminal.

18. The apparatus according claim 17, wherein
said mobility procedure with respect to said terminal is any one of a handover procedure, a redirection procedure, or a radio access network based notification area update procedure.
